(19) United States
(12) Patent Application Publication
(10) Pub. No.: US 2010/0128686 A1
(43) Pub. Date: May 27, 2010

(54) RADIO COMMUNICATION BASE STATION DEVICE AND RESOURCE SHARING METHOD

(75) Inventors: Akihiko Nishio, Kanagawa (JP); Daichi Imamura, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/598,432

(22) PCT Filed: Apr. 30, 2008
(86) PCT No.: PCT/JP2008/001119

§ 371 Date: Oct. 31, 2009

(30) Foreign Application Priority Data
May 1, 2007 (JP) 2007-120848

(51) Int. Cl. H04W 72/04

(52) U.S. Cl. 370/329

(57) ABSTRACT

A radio communication base station device capable of reducing the downlink resources required for ACK/NACK channels to improve data transmission efficiency. In this device, an allocation control channel allocating section (101) allocates inputted uplink allocation information (#1 to #K) to any of allocation control channels (CH#1 to #K). An ACK/NACK channel allocating section (105) allocates an acknowledgment signal with respect to each mobile station to the allocation control channel in which the uplink allocation information of each mobile station is allocated and an ACK/NACK channel associated with the number of transmission of the uplink data of each mobile station. An arrangement section (106) arranges the ACK/NACK channel to which the acknowledgment signal is allocated in a downlink resource shared by a plurality of ACK/NACK channels including the ACK/NACK channel to which the acknowledgment signal is allocated.

### TECHNICAL FIELD

The present invention relates to a radio communication base station apparatus and resource sharing method.

### BACKGROUND ART

In mobile communications, ARQ (Automatic Repeat reQuest) is applied to uplink data that is transmitted in uplink from a radio communication mobile station apparatus (hereinafter simply “mobile station”) to a radio communication base station apparatus (hereinafter simply “base station”), and a response signal showing an uplink data error detection result is fed back to the mobile station in downlink. The base station performs a CRC (Cyclic Redundancy Check) on the uplink data, and feeds back an ACK (Acknowledgment) signal if CRC=OK (no error) or a NACK (Negative Acknowledgment) signal if CRC=NG (error), as a response signal to the mobile station.

Here, studies are underway to apply synchronous HARQ (Hybrid ARQ) to uplink data. In synchronous HARQ, a base station feeds back a response signal to a mobile station a predetermined time after receiving uplink data, while, if a NACK signal is fed back from the base station, the mobile station retransmits uplink data to the base station a predetermined time after receiving the NACK signal. Also, in synchronous HARQ, in order to use downlink communication resources efficiently, studies are underway to associate a downlink allocation control channel for allocating uplink resources to mobile stations and the number of uplink data transmissions, with ACK/NACK channels for transmitting response signals in downlink (see Non-Patent Document 1). By this means, even if ACK/NACK channel allocation information is not notified separately, a mobile station can identify the ACK/NACK channel for that the mobile station according to an allocation control channel and the number of uplink data transmissions from the base station.

Non-Patent Document 1: 3GPP RAN WGI Meeting document, RI-070932, “Allocation of Downlink ACK/NACK Channel”, Panasonic, February 2007

### DISCLOSURE OF INVENTION

### Problems to be Solved by the Invention

With the above conventional art, to transmit a response signal, it is necessary to reserve downlink resources equivalent to the number of ACK/NACK channels multiplying the number of allocation control channels and the maximum number of transmissions.

However, it is rare to perform retransmissions up to the maximum possible number of transmissions, and, consequently, resources reserved for response signals to uplink data associated with a large number of transmissions, are wasted.

It is therefore an object of the present invention to provide a base station and resource sharing method that can reduce downlink resources required for ACK/NACK channels and improve the data transmission efficiency.

### Means for Solving the Problem

The base station of the present invention employs a configuration having: a first allocating section that allocates resource allocation information of uplink data to a first control channel; a second allocating section that allocates a response signal to the uplink data, to a second control channel associated with the first control channel and a number of uplink data transmissions; and a placing section that places the second control channel in a downlink resource shared by a plurality of second control channels including the second control channel.

### ADVANTAGEOUS EFFECT OF INVENTION

According to the present invention, it is possible to reduce downlink resources required for ACK/NACK channels and improve the data transmission efficiency.

### BRIEF DESCRIPTION OF DRAWINGS

FIG. 1 is a block diagram showing the configuration of a base station according to Embodiment 1 of the present invention;

FIG. 2 is a sequence diagram of ARQ according to Embodiment 1 of the present invention;

FIG. 3 shows downlink resources according to Embodiment 1 of the present invention (example 1-1);

FIG. 4 is a sequence diagram of ARQ according to Embodiment 1 of the present invention (example 1-2);

FIG. 5 shows downlink resources according to Embodiment 1 of the present invention (example 1-3);

FIG. 6 shows an MCS table according to Embodiment 1 of the present invention (example 1-4);

FIG. 7 shows downlink resources according to Embodiment 1 of the present invention (example 1-4);

FIG. 8 shows downlink resources according to Embodiment 1 of the present invention (example 1-5);

FIG. 9 shows downlink resources according to Embodiment 1 of the present invention (example 1-6-1);

FIG. 10 shows downlink resources according to Embodiment 1 of the present invention (example 1-6-2);

FIG. 11 shows physical resources according to Embodiment 1 of the present invention;

FIG. 12 shows CCE's according to Embodiment 2 of the present invention (example 2-1);

FIG. 13 shows downlink resources according to Embodiment 2 of the present invention (example 2-1);

FIG. 14 shows CCE's according to Embodiment 2 of the present invention (example 2-2);

FIG. 15 shows downlink resources according to Embodiment 2 of the present invention (example 2-2);

FIG. 16 shows downlink resources (example 1); and

FIG. 17 shows downlink resources (example 2).

### BEST MODE FOR CARRYING OUT THE INVENTION

Embodiments of the present invention will be explained below in detail with reference to the accompanying drawings.

### Embodiment 1

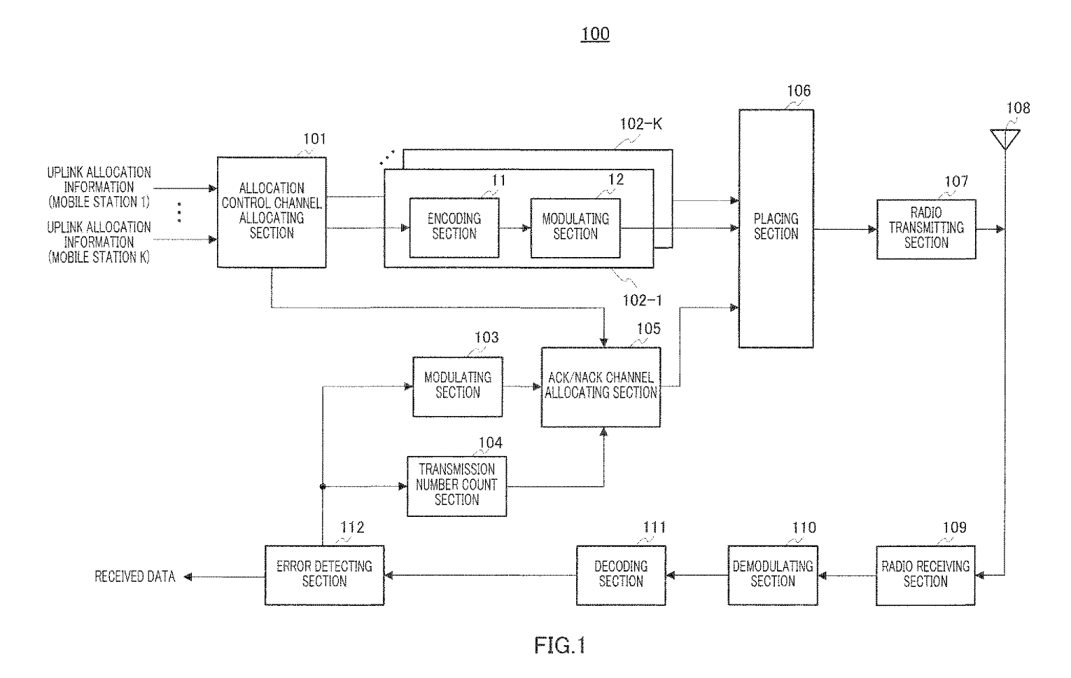

FIG. 1 is a block diagram showing the configuration of base station 100 according to the present embodiment.

Here, to avoid complicated explanation, FIG. 1 illustrates components relating to the transmission of uplink allocation information in downlink, components relating to the transmission of a response signal to uplink data in downlink, and components relating to the reception of uplink data, which are closely related to the present invention, while the components relating to the transmission of downlink data will be omitted from the drawings and description.

In base station 100 shown in FIG. 1 allocation control channel allocating section 101 receives as input uplink allocation information #1 to #K indicating which uplink resource is allocated to which mobile station amongst maximum K mobile stations #1 to #K. Allocation control channel allocating section 101 allocates uplink allocation information #1 to #K received as input, to allocation control channels CH #1 to #K. Allocation control channel allocating section 101 outputs uplink allocation information #1 to #K, individually, to encoding and modulating sections 102-1 to 102-K, associated with the allocation control channels respectively. Further, allocation control channel allocating section 101 outputs, to ACK/NACK channel allocating section 105, control channel allocation information indicating to which allocation control channel the uplink allocation information of which mobile station is allocated.

Encoding and modulating section 102-1 to 102-K are provided in association with allocation control channels #1 to #K. In encoding and modulating section 102-1 to 102-K, encoding sections 11 encode uplink allocation information received as input, and output the results to modulating sections 12. Next, modulating sections 12 generate uplink allocation information symbols by modulating the encoded uplink allocation information received as input from encoding sections 11, and output the results to placing section 106.

Modulating section 103 modulates the response signal of each mobile station received as input from error detecting section 112. Modulating section 103 then outputs the modulated response signals to ACK/NACK channel allocating section 105.

Transmission number count section 104 counts the number of uplink data transmissions on a per mobile station basis, based on the response signal to each mobile station received as input from error detecting section 112. That is, transmission number count section 104 counts the number of times NACK signals are consecutively received as input, and resets the number of transmissions when receiving as input an ACK signal. Further, transmission number count section 104 outputs the number of transmissions to ACK/NACK channel allocating section 105.

ACK/NACK channel allocating section 105 allocates a response signal received as input from modulating section 103, to an ACK/ANCK channel based on control channel allocation information received as input from allocation control channel allocating section 101 and the number of transmissions received as input from transmission number count section 104. That is, ACK/NACK channel allocating section 105 allocates the response signal to each mobile station to an ACK/NACK channel associated with an allocation control channel, to which uplink allocation information is allocated, and with the number of uplink data transmissions. ACK.NACK channel allocating section 105 then outputs the response signals allocated to the ACK/NACK channel, to placing section 106.

Placing section 106 places an allocation control channel, to which an uplink allocation information symbol is allocated, in a downlink resource reserved for an allocation control channel, and places an ACK/NACK channel, to which a response signal is allocated, in a downlink resource shared by a plurality of ACK/NACK channels including that ACK/NACK channel. Placing section 106 then outputs the signals, in which channels are placed, to radio transmitting section 107. Here, a downlink resource is shared by a plurality of ACK/NACK channels associated with a plurality of allocation control channels, respectively. An example of downlink resource sharing will be described later in detail.

Radio transmitting section 107 performs transmission processing such as D/A conversion, amplification and up-conversion for the signals received as input from placing section 106, and transmits the results from antenna 108 to each mobile station.

On the other hand, radio receiving section 109 receives uplink data transmitted from each mobile station via antenna 108, and performs reception processing such as down-conversion and A/D conversion for this uplink data.

Demodulating section 110 demodulates the uplink data and outputs the demodulated uplink data to decoding section 111.

Decoding section 111 decodes the demodulated uplink data and outputs the decoded uplink data to error detecting section 112.

Error detecting section 112 performs error detection using a CRC on the decoded uplink data, generates an ACK signal if CRC=OK (no error) or a NACK signal if CRC=NG (error), as a response signal, and outputs the generated response signal to modulating section 103 and transmission number count section 104. Further, if CRC=OK (no error), error detecting section 112 outputs the decoded uplink data as received data.

By contrast, upon receiving an allocation control channel for each subject mobile station from a base station, each mobile station transmits transmission data to the base station based on uplink allocation information and MCS (Modulation and Coding Scheme). Further, each mobile station receives a response signal allocated to an ACK/NACK channel associated with the allocation control channel for each subject mobile station and with the number of transmission data transmissions. Here, in each mobile station, which ACK/NACK channel is associated with which downlink resource, is designated by a higher layer or determined in advance. Further, if the response signal is an ACK signal, for transmitting next transmission data, each mobile station waits until an allocation control channel for each subject mobile station is transmitted from the base station. By contrast, if the response signal is a NACK signal, each mobile station retransmits transmission data.

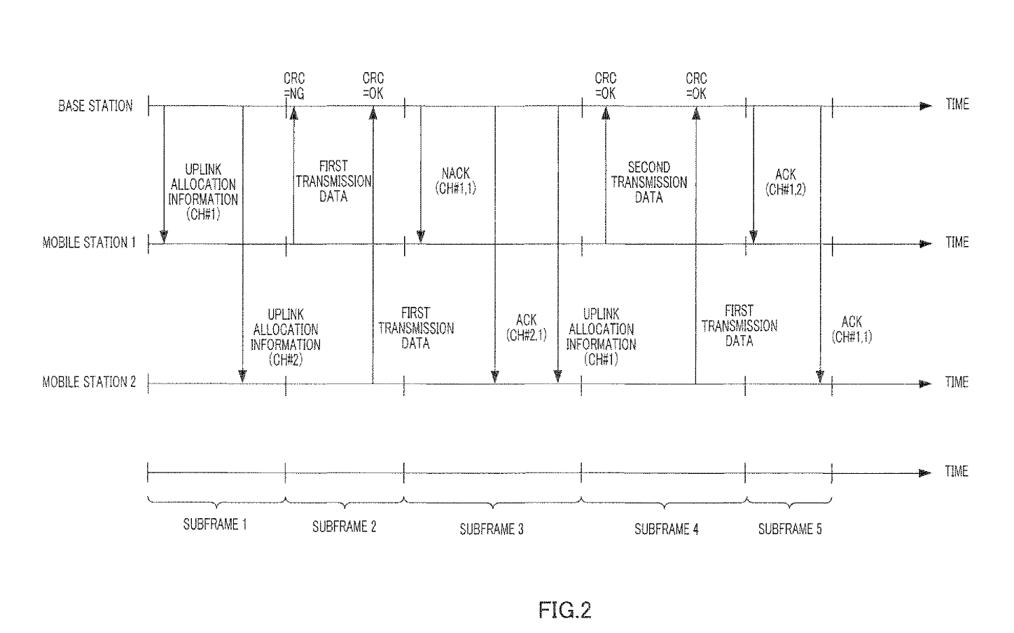

Next, FIG. 2 illustrates a sequence example in detail according to the present embodiment. The base station shown in FIG. 2 employs the above configuration shown in FIG. 1. Here, an ACK/NACK channel associated with allocation control channel CH #x and the number of transmissions y, is referred to as “ACK/NACK channel CH #x, y.”

First, in subframe #1, the base station allocates, to allocation control channel CH #1, uplink allocation information indicating that an uplink resource is allocated to mobile station 1, and transmits the result, and allocates, to allocation control channel CH #2, uplink allocation information indicating that an uplink resource is allocated to mobile station 2, and transmits the result.

Mobile station 1 having received uplink allocation information for that mobile station transmits uplink data in subframe 2 (the first transmission), and mobile station 2 having received uplink allocation information for that mobile station transmits uplink data in subframe 2 (the first transmission).

The base station having received the uplink data from mobile station 1 performs a CRC for this uplink data. If CRC=NG (error), the base station feeds back a NACK signal in subframe 3. Here, the NACK signal fed back is allocated to ACK/NACK channel CH #1, 1 associated with allocation control channel CH #1 (x=1) and the first transmission (y=1).

On the other hand, the base station having received the uplink data from mobile station #2 performs a CRC for this uplink data. If CRC=OK (no error), the base station feeds back an ACK signal in subframe 3. Here, the ACK signal fed back is allocated to ACK/NACK channel CH #2, 1 associated with allocation control channel CH #2 (x=2) and the first transmission (y=1).

Further, in subframe 3, the base station allocates, to allocation control channel CH #1, uplink allocation information indicating that an uplink resource is allocated to mobile station 2, and transmits the result.

Next, mobile station 1 having received a NACK signal in subframe 3 retransmits uplink data in subframe 4 (a second transmission). Also, mobile station 2 having received an ACK signal in subframe 3 and further received the uplink allocation information for that mobile station, transmits uplink data in subframe 4 (the first transmission).

The base station having received uplink data from mobile station 1 performs a CRC for this uplink data. If CRC=OK (no error), the base station feeds back an ACK signal in subframe 5. Here, the ACK signal fed back is allocated to ACK/NACK channel CH #1, 2 associated with allocation control channel CH #1 (x=1) and the second transmission (y=2).

Also, the base station having received the uplink data from mobile station #2 performs a CRC for this uplink data. If CRC=OK (no error), the base station feeds back an ACK signal in subframe 5. Here, the ACK signal fed back is allocated to ACK/NACK channel CH #1, 1 associated with allocation control channel CH #1 (x=1) and the first transmission (y=1).

Next, an example of downlink resource sharing according to the present embodiment will be explained in detail. In the following explanation, allocation control channels are represented by four allocation control channels CH #1 to CH #4, and the maximum number of uplink data transmissions is assumed six.

### Sharing Example 1-1

In this example, a downlink resource is shared by an ACK/NACK channel associated with a larger number of transmissions and the ACK/NACK channel associated with a smaller number of transmissions.

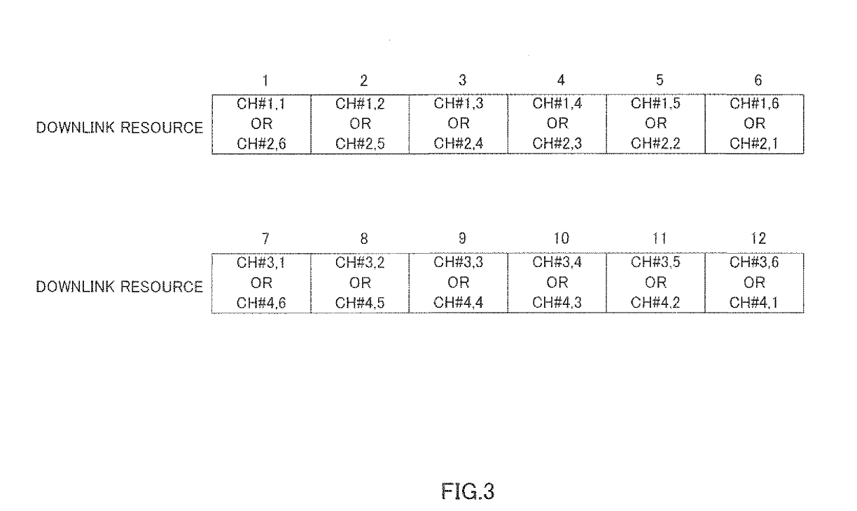

To be more specific, as shown in FIG. 3, downlink resource 1 is shared by ACK/NACK channel CH #1, 1, which is associated with allocation control channel CH #1 and the first transmission (the initial transmission), and ACK/NACK channel CH #2, 6, which is associated with allocation control channel CH #2 and the sixth transmission (the fifth retransmission), which is the maximum number of transmissions. Also, downlink resource 2 is shared by ACK/NACK channel CH #1, 2, which is associated with allocation control channel CH #1 and the second transmission (the first retransmission), and ACK/NACK channel CH #2, 5, which is associated with allocation control channel CH #2 and the fifth transmission (the fourth retransmission). Also, downlink resource 3 is shared by ACK/NACK channel CH #1, 3, which is associated with allocation control channel CH #1 and the third transmission (the second retransmission), and ACK/NACK channel CH #2, 4, which is associated with allocation control channel CH #2 and the fourth transmission (the third retransmission). Also, downlink resource 4 is shared by ACK/NACK channel CH #1, 4, which is associated with allocation control channel. CH #1 and the fourth transmission (the third retransmission), and ACK/NACK channel CH #2, 3, which is associated with allocation control channel CH #2 and the third transmission (the second retransmission). Also, downlink resource 5 is shared by ACK/NACK channel CH #1, 5, which is associated with allocation control channel CH #1 and the fifth transmission (the fourth retransmission), and ACK/NACK channel CH #2, 2, which is associated with allocation control channel CH #2 and the second transmission (the first retransmission). Also, downlink resource 6 is shared by ACK/NACK channel CH #1, 6, which is associated with allocation control channel CH #1 and the sixth transmission (the fifth retransmission), which is the maximum number of transmissions, and ACK/NACK channel CH #2, 1, which is associated with allocation control channel CH #2 and the first transmission (the initial transmission),

That is, as shown in FIG. 3, ACK/NACK channels CH #1, 1 to CH #1, 6, associated with allocation control channel CH 41, are placed such that these ACK/NACK channels are arranged from downlink resource 1 to downlink resource 6, in ascending order of the number of transmissions. Also, ACK/NACK channels CH #2, 1 to CH #2, 6 associated with allocation control channel CH #2 are placed such that these ACK/NACK channels are arranged from downlink resource 6 to downlink resource 1, in descending order of the number of transmissions.

Here, the sum of the larger number of transmissions and the smaller number of transmissions is the same, between downlink resources 1 to 6. That is, in downlink resources 1 to 6, the sum of the numbers of transmissions associated with ACK/NACK channels sharing each downlink resource is the same, 7, between all downlink resources.

Also, the same applies to downlink resources 7 to 12. That is, in ACK/NACK channels CH #3, 1 to CH #3, 6, associated with allocation control channel CH #3, and ACK/NACK channels CH #4, 1 to CH #4, 6, associated with allocation control channel CH #4, as shown in FIG. 3, downlink resources are shared by ACK/NACK channels associated with the larger numbers of transmissions and ACK/NACK channels associated with the smaller numbers of transmissions. That is, as shown in FIG. 3, ACK/NACK channels CH #3, 1 to CH #3, 6, associated with allocation control channel CH #3, are placed such that these ACK/NACK channels are arranged from downlink resource 7 to downlink resource 12, in ascending order of the number of transmissions. Also, ACK/NACK channels CH #4, 1 to CH #4, 6, associated with allocation control channel CH #4, are placed such that these ACK/NACK channels are arranged from downlink resource 12 to downlink resource 7, in descending order of the number of transmissions.

Thus, if the number of allocation control channels is four and the maximum number of uplink data transmissions is six, twenty-four (4×6) downlink resources are required to use different downlink resources between ACK/NACK channels, while, if downlink resources are shared as shown in this example, half of the downlink resources, that is, twelve downlink resources need to be reserved. That is, the remaining twelve downlink resources can be reserved for data, so that it is possible to improve the data transmission efficiency.

Also, generally, most mobile stations can complete data transmission with a small number of transmissions, and therefore using ACK/NACK channels associated with a larger number of transmissions is extremely rare. Therefore, in downlink resources 1 to 3 (downlink resources 7 to 9) shown in FIG. 3, ACK/NACK channels CH #1, 1 to CH #1, 3 (CH #3, 1 to CH #3, 3), associated with allocation control channel CH #1 (CH #3) and the smaller numbers of transmissions, are used more frequently, while ACK/NACK channels CH #2, 6 to CH #2, 4 (CH #4, 6 to CH #4, 4), associated with allocation control channel CH #2 (CH #4) and the larger numbers of transmissions, are used less frequently.

Also, in downlink resources 4 to 6 (downlink resources 10 to 12) shown in FIG. 3, ACK/NACK channels CH #1, 4 to CH #1, 6 (CH #3, 4 to CH #3, 6), associated with allocation control channel CH #1 (CH #3) and the larger numbers of transmissions, are used less frequently, while ACK/NACK channels CH #2, 3 to CH #2, 1 (CH #4, 3 to CH #4, 1), associated with allocation control channel CH #2 (CH #4) and the smaller numbers of transmissions, are used more frequently.

By this means, in downlink resources 1 to 6 (downlink resources 7 to 12) shown in FIG. 3, there is a low possibility that two ACK/NACK channels sharing the same downlink resource are used in the same subframe at the same time.

Thus, according to this example, a downlink resource is shared by an ACK/NACK channel associated with the larger number of transmissions and an ACK/NACK channel associated with the smaller number of transmissions. Therefore, by different ACK/NACK channels, it is possible to use downlink resources evenly and reduce the possibility that a plurality of ACK/NACK channels sharing the same downlink resource are used at the same time. By this means, it is possible to use downlink resources for ACK/NACK channels efficiently and reduce the downlink resources required for ACK/NACK channels.

### Sharing example 1-2

As in sharing example 1-1, by sharing a downlink resource by an ACK/NACK channel associated with the larger number of transmissions and an ACK/NACK channel associated with the smaller number of transmissions, it is possible to use downlink resources efficiently.

However, if a plurality of ACK/NACK channels, associated with a plurality of allocation control channels respectively, use the same downlink resource at the same time, there may remain a possibility that ACK/NACK channels collide with each other. For example, when mobile station 1 allocated by allocation control channel CH #1 performs the fourth transmission and mobile station #2 allocated by allocation control channel CH #2 performs the third transmission, as shown in FIG. 3, the base station allocates respective response signals to ACK/NACK channel CH #1, 4 and ACK/NACK channel CH #2, 3, and therefore ACK/ANCK channels collide with each other in downlink resource 4.

Here, with this example, to avoid a collision of different ACK/NACK channels in the same downlink resource, a response signal is allocated to an ACK/NACK channel associated with the number of uplink data transmissions after an allocation control channel is notified.

Allocation control channel allocating section 101 according to this example receives as input ACK/NACK channel allocation information indicating which response signal is allocated to which ACK/NACK channel, from ACK/NACK channel allocating section 105. Allocation control channel allocating section 101 decides whether or not a plurality of response signals are allocated at the same time to a plurality of ACK/NACK channels shared by the same downlink resource, based on the ACK/NACK channel allocation information. Here, if a plurality of response signals are allocated at the same time to a plurality of ACK/NACK channels, allocation control channel allocating section 101 reallocates uplink allocation information for one of mobile stations, to which allocation control channels associated with the ACK/NACK channels are allocated, to the same allocation control channel.

Transmission number count section 104 receives as input control channel allocation information from allocation control channel allocating section 101. Further, when uplink allocation information is reallocated to an allocation control channel, transmission number count section 104 sets the number of uplink data transmissions from the mobile station, to which the allocation control channel is allocated, to the initial state.

That is, an allocation control channel plays a role of resetting the number of uplink data transmissions.

On the other hand, upon receiving a response signal, a mobile station receives an allocation control channel at the same time. Further, when a mobile station receives a NACK signal and an allocation control channel for that mobile station, the mobile station receives response signals to the next and subsequent uplink data that are retransmitted, using ACK/NACK channels in order, back from the ACK/NACK channel associated with the first transmission again.

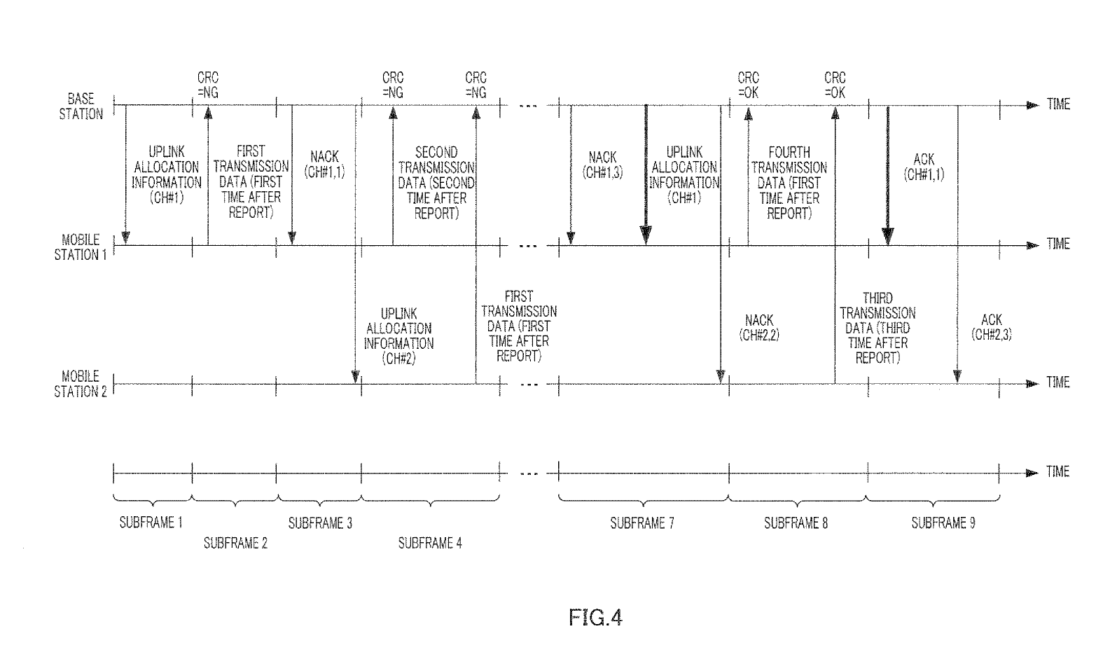

Next, FIG. 4 shows a sequence example according to the present embodiment in detail. Here, as in sharing example 1-1, as shown in FIG. 3, a downlink resource is shared by different ACK/NACK channels.

First, in subframe 1, the base station allocates uplink allocation information indicating that an uplink resource is allocated to mobile station 1, to allocation control channel CH #1, and transmits the result.

Mobile station 1 having received the uplink allocation information for that mobile station, transmits uplink data in subframe 2 (the first transmission).

The base station having received the uplink data from mobile station 1 performs a CRC for this uplink data. If CRC=NG (error), the base station feeds back a NACK signal in subframe 3. Here, the NACK signal fed back is allocated to ACK/NACK channel CH #1, 1, associated with allocation control channel CH #1 and the first transmission after allocation control channel CH #1 is notified.

Further, in subframe 3, the base station allocates uplink allocation information indicating that an uplink resource is allocated to mobile station 2, to allocation control channel CH #2, and transmits the result.

Mobile station 1 having received a NACK signal in subframe 3 retransmits uplink data in subframe 4 (the second transmission). Also, mobile station 2 having received the uplink allocation information for that mobile station in subframe 3, transmits uplink data in subframe 4 (the first transmission).

Next, the base station having received individual uplink data from mobile station 1 and mobile station 2 performs a CRC for these uplink data, and, if CRC=NG (error), feeds back a NACK signal for each mobile station in subframe 5 (not shown). Here, the NACK signal for mobile station 1 is allocated to ACK/NACK channel CH #1, 2 associated with allocation control channel CH #1 and the second transmission after a notification with allocation control channel CH 41. On the other hand, the NACK signal for mobile station 2 is allocated to ACK/NACK channel CH #2, 1 associated with allocation control channel CH #2 and the first transmission after a notification with allocation control channel CH #2.

Also, in subframe 6 (not shown), mobile station 1 transmits uplink data (the third transmission), and mobile station 2 transmits uplink data (the second transmission).

Similarly, the base station having received individual uplink data from mobile station 1 and mobile station 2 performs a CRC for these uplink data. Further, if CRC=NG (error), the base station feeds back the NACK signal for each mobile station in subframe 7. The NACK signal for mobile station 1 is allocated to ACK/NACK channel CH #1, 3, associated with allocation control channel CH #1 and the third transmission after a notification with allocation control channel CH #1, while the NACK signal for mobile station 2 is allocated to ACK/NACK channel CH #2, 2, associated with allocation control channel CH #2 and the second transmission after a notification with allocation control channel CH #2.

Here, as shown in FIG. 3, ACK/NACK channel CH #1, 3 is placed in downlink resource 3, and ACK/NACK channel CH #2, 2 is placed in downlink resource 5. Therefore, response signals to uplink data that are transmitted from mobile station 1 and mobile station 2 in next subframe 8, are ACK/NACK channel CH #1, 4 and ACK/NACK channel CH #2, 3, respectively. That is, the same downlink resource 4 is used, and therefore ACK/NACK channels collide with each other.

Therefore, in subframe 7, the base station transmits a NACK signal to mobile station 1, and, at the same time, allocates uplink allocation information indicating that an uplink resource is allocated to mobile station 1, to the same allocation control channel as allocation control channel CH #1 as in subframe 1, and transmitting the result. Here, although a mobile station to which an allocation control channel is transmitted is not limited to mobile station 1 and may be mobile station 2, it is preferable to send notice to a mobile station with a larger number of transmissions associated with ACK/NACK channels, in order to reduce the number of allocation control channels that are transmitted to reset the number of transmissions.

Next, mobile station 1 having received a NACK signal in subframe 7 retransmits uplink data in subframe 8 (the fourth transmission). Here, mobile station 1 having received the uplink allocation information for that mobile station again performs redefinition so as to receive a response signal to retransmitted uplink data by the ACK/NACK channel associated with the first transmission. Also, mobile station 2 having received a NACK signal in subframe 7 transmits uplink data in subframe 8 (the third transmission).

The base station having received the uplink data from mobile station 1 performs a CRC for this uplink data. If CRC=OK (no error), the base station feeds back an ACK signal in subframe 9. Here, the ACK signal fed back is allocated to ACK/NACK channel CH #1, 1 associated with allocation control channel CH #1 and the first transmission after a notification with allocation control channel CH #1.

Also, the base station having received the uplink data from mobile station 2 performs a CRC for this uplink data. If CRC=OK (no error), the base station feeds back an ACK signal in subframe 9. Here, the ACK signal fed back is allocated to ACK/NACK channel CH #2, 3 associated with allocation control channel CH #2 and the third transmission after a notification with allocation control channel CH #2.

Thus, according to this example, by resetting the ACK/NACK channel to which a response signal to mobile station 1 is allocated in subframe 9 shown in FIG. 4, it is possible to avoid a collision of an ACK/NACK channel, to which a response signal to mobile station 1 is allocated, and an ACK/NACK channel, to which a response signal to mobile station 2 is allocated.

Also, although a case has been described above with this example where an ACK/NACK channel associated with the first transmission is used after an allocation control channel is notified to a mobile station again, the present invention may notify information indicating which ACK/NACK channel is used, upon notifying an allocation control channel to a mobile station again.

Also, although an allocation control channel is used to reset downlink resource allocation in this example, it is equally possible to use an allocation control channel to prevent data transmission efficiency from becoming poor due to fragmentation of data resources when single carrier transmission is used in uplink. In this case, the allocation control channel may contain information indicating which data resource is reallocated to which mobile station.

Also, in this example, although the same allocation control channel as an allocation control channel (such as allocation control channel CH #1), to which uplink resource allocation information is allocated upon the first transmission (the initial transmission), is used to reset an downlink resource allocation, it is equally possible to use a different allocation control channel (e.g. allocation control channel CH 43). In this case, for the next retransmission, an ACK/NACK channel associated with an allocation control channel that is newly used, is used.

### Sharing Example 1-3

Although this example is the same as sharing example 1-1 in that a downlink resource is shared by an ACK/NACK channel associated with the larger number of transmissions and an ACK/NACK channel associated with the smaller number of transmissions, this example differs from sharing example 1-1 in sharing a plurality of downlink resources by a plurality of ACK/NACK channels arranged in ascending order of the number of uplink data transmissions.

To be more specific, as shown in FIG. 5, downlink resource 1 is shared by ACK/NACK channel CH #1, 1, which is associated with allocation control channel CH #1 and the first transmission (the initial transmission), and ACK/NACK channel CH #4, 4, which is associated with allocation control channel CH #4 and the fourth transmission (the third retransmission). Also, downlink resource 2 is shared by ACK/NACK channel CH #1, 2, which is associated with allocation control channel CH #1 and the second transmission (the first retransmission), and ACK/NACK channel CH #4, 5, which is associated with allocation control channel CH #4 and the fifth transmission (the fourth retransmission). Also, downlink resource 3 is shared by ACK/NACK channel CH #1, 3, which is associated with allocation control channel CH #1 and the third transmission (the second retransmission), and ACK/NACK channel CH #4, 6, which is associated with allocation control channel CH #4 and the sixth transmission (the fifth retransmission), which is the maximum number of transmissions. Also, downlink resource 4 is shared by ACK/NACK channel CH #1, 4, which is associated with allocation control channel CH #1 and the fourth transmission (third retransmission), and ACK/NACK channel CH #2, 1, which is associated with allocation control channel CH #2 and the first transmission (the initial transmission). Also, downlink resource 5 is shared by ACK/NACK channel CH #1, 5, which is associated with allocation control channel CH #1 and the fifth transmission (the fourth retransmission), and ACK/NACK channel CH #2, 2, which is associated with allocation control channel CH #2 and the second transmission (the first retransmission). Also, downlink resource 6 is shared by ACK/NACK channel CH #1, 6, which is associated with allocation control channel CH #1 and the sixth transmission (the fifth retransmission), which is the maximum number of transmissions, and ACK/NACK channel CH #2, 3, which is associated with allocation control channel CH #2 and the third transmission (the second retransmission).

Similarly, as shown in FIG. 5, downlink resource 7 is shared by ACK/NACK channel CH #3, 1, which is associated with allocation control channel CH #3 and the first transmission (the initial transmission), and ACK/NACK channel CH #2, 4, which is associated with allocation control channel CH #2 and the fourth transmission (the third retransmission). Also, downlink resource 8 is shared by ACK/NACK channel CH #3, 2, which is associated with allocation control channel CH #3 and the second transmission (the first retransmission), and ACK/NACK channel CH #2, 5, which is associated with allocation control channel CH #2 and the fifth transmission (the fourth retransmission). Also, downlink resource 9 is shared by ACK/NACK channel CH #3, 3, which is associated with allocation control channel CH #3 and the third transmission (the second retransmission), and ACK/NACK channel CH #2, 6, which is associated with allocation control channel CH #2 and the sixth transmission (the fifth retransmission), which is the maximum number of transmissions. Also, downlink resource 10 is shared by ACK/NACK channel CH #3, 4, which is associated with allocation control channel CH #3 and the fourth transmission (the third retransmission), and ACK/NACK channel CH #4, 1, which is associated with allocation control channel CH #4 and the first transmission (the initial transmission). Also, downlink resource 11 is shared by ACK/NACK channel CH #3, 5, which is associated with allocation control channel CH #3 and the fifth transmission (the fourth retransmission), and ACK/NACK channel CH #4, 2, which is associated with allocation control channel CH #4 and the second transmission (the first retransmission). Also, downlink resource 12 is shared by ACK/NACK channel CH #3, 6, which is associated with allocation control channel CH #3 and the sixth transmission (the fifth retransmission), which is the maximum number of transmissions, and ACK/NACK channel CH #4, 3, which is associated with allocation control channel CH #4 and the third transmission (the second retransmission).

That is, as shown in FIG. 5, ACK/NACK channels CH #1, 1 to CH #1, 6 associated with allocation control channel CH #1 are placed in downlink resources 1 to 6 such that these ACK/NACK channels are arranged from downlink resource 1 to downlink resource 6, in ascending order of the number of transmissions. Also, ACK/NACK channels CH #2, 1 to CH #2, 6 associated with allocation control channel CH #2 are placed in downlink resources 4 to 9 such that these ACK/NACK channels are arranged from downlink resource 4 to downlink resource 9, in ascending order of the number of transmissions. Also, ACK/NACK channels CH #3, 1 to CH #3, 6 associated with allocation control channel CH #3 are placed in downlink resources 7 to 12 such that these ACK/NACK channels are arranged from downlink resource 7 to downlink resource 12, in ascending order of the number of transmissions. Also, ACK/NACK channels CH #4, 1 to CH #4, 6 associated with allocation control channel CH #4 are placed in downlink resources 10 to 12 and downlink resources 1 to 3 such that these ACK/NACK channels are arranged from downlink resource 10 to downlink resource 12 and downlink resource 1 to downlink resource 3, in ascending order of the number of transmissions. That is, in downlink resources 1 to 12, as shown in FIG. 5, ACK/NACK channels, associated with allocation control channels CH #1 to CH #4, are arranged and placed in ascending order of the number of transmissions such that allocation control channels shift in units of three downlink resources.

Further, as shown in FIG. 5, in downlink resources 1 to 12, the numbers of transmissions associated with two ACK/NACK channels sharing the same downlink resource are one of the combination of the first transmission and the fourth transmission, the combination of the second transmission and the fifth transmission, and the combination of the third transmission and the sixth transmission. That is, a downlink resource is shared by an ACK/NACK channel associated with the larger number of transmissions and an ACK/NACK channel associated with the smaller number of transmissions, so that there is a low possibility that the same downlink resource is used at the same time in the same subframe.

Further, when a response signal to a different mobile station is already allocated to a different ACK/NACK channel sharing the same downlink resource with an ACK/NACK channel associated with an allocation control channel and the first transmission, the base station allocates uplink allocation information to one of allocation control channels other than the allocation control channel associated with the first transmission sharing the same downlink resource with that different ACK/NACK channel.

For example, in downlink resources shown in FIG. 5, when a response signal to a different mobile station is already allocated to ACK/NACK channel CH #1, 4 in downlink resource 4, uplink allocation information is allocated to one of allocation control channels CH #1, CH #3 and CH #4, other than allocation control channel CH #2 associated with ACK/NACK channel CH#2, 1 sharing the same downlink resource 4 with ACK/NACK channel #1, 4.

Thus, for an ACK/NACK channel associated with the first transmission in downlink resources 1 to 12 shown in FIG. 5, if a collision of ACK/NACK channels associated with the first transmission is avoided in advance, ACK/NACK channels associated with allocation control channels shift in parallel in downlink resources, in ascending order, even when the number of transmissions increases. By this means, ACK/NACK channels do not collide with each other.

Thus, with this example, it is possible to produce the same effect as in sharing example 1-1, without transmitting an allocation control channel to avoid a collision of ACK/NACK channels unlike sharing example 1-2. Also, as in sharing example 1-2, if a receiving error occurs in an allocation control channel that is transmitted to avoid a collision of ACK/NACK channels, it may not be possible to avoid a collision of ACK/NACK channels. However, with this example, allocation control channels are allocated so as to avoid a collision of ACK/NACK channels in advance, so that it is surely possible to avoid a collision.

### Sharing Example 1-4

In this example, a downlink resource is shared by an ACK/NACK channel associated with an allocation control channel of the higher MCS level and an ACK/NACK channel associated with an allocation control channel of the lower MCS level.

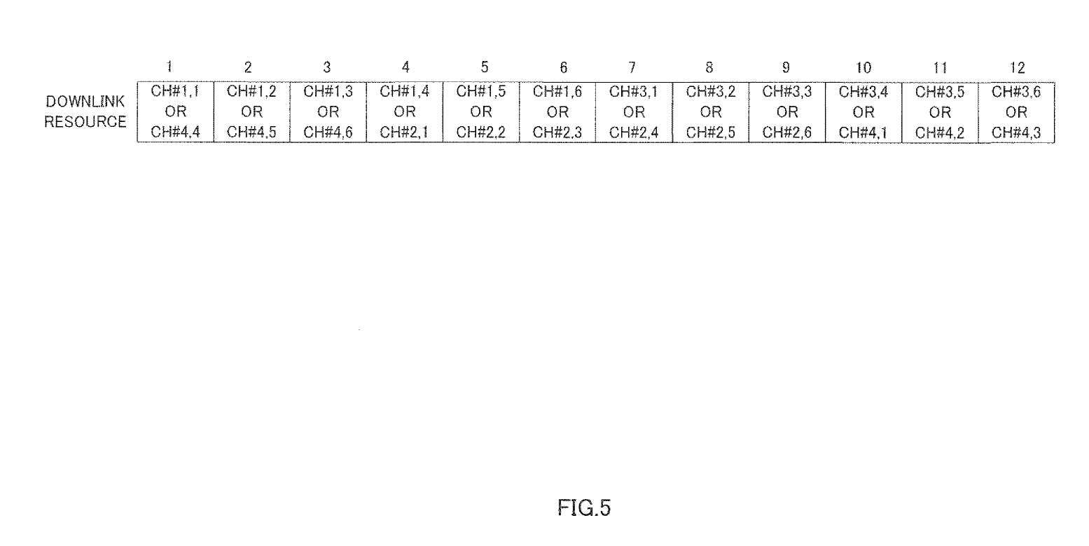

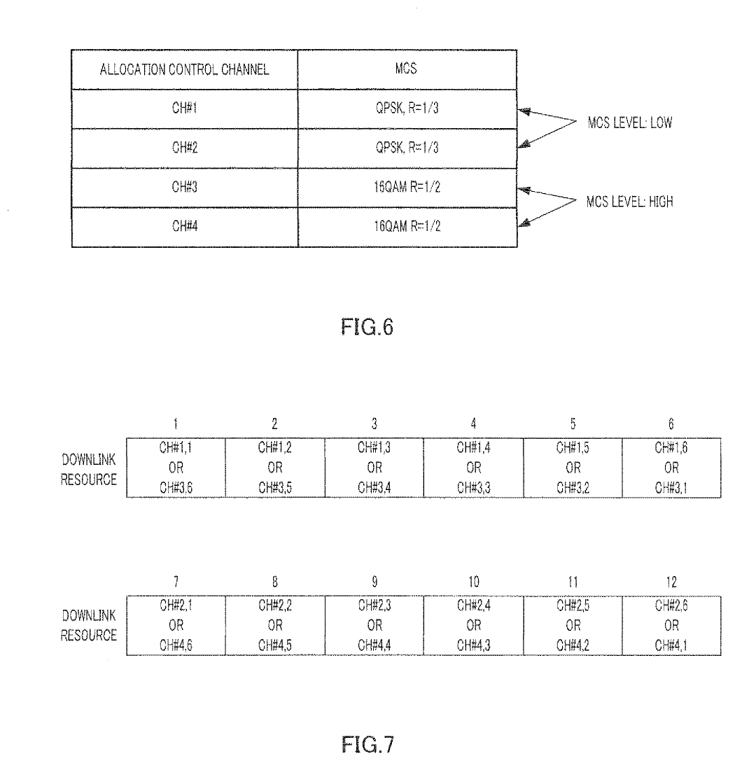

Allocation control channel allocating section 101 according to this example receives as input CQI (Channel Quality Indicator) information indicating the channel quality of each mobile station from a CQI measuring section (not shown). Allocation control channel allocating section 101 allocates uplink allocation information #1 to #K to allocation control channels CH #1 to CH #K, based on the CQI information. To be more specific, allocation control channel allocating section 101 allocates uplink allocation information to one of allocation control channels CH #1 to CH #4, based on the MCS table shown in FIG. 6 and CQI information. For example, if the MCS matching CQI information is the QPSK modulation scheme and coding rate R-1/3 shown in FIG. 6, allocation control channel allocating section 101 allocates uplink allocation information to one of allocation control channels CH #1 and CH #2. Also, if the MCS matching CQI information is the 16 QAM modulation scheme and coding rate R=1/2 shown in FIG. 6, allocation control channel allocating section 101 allocates uplink allocation information to one of allocation control channels CH #3 and CH #4.

Encoding and modulating sections 102-1 to 102-K, supporting respective fixed respective MCS levels encode uplink allocation information #1 to #K received as input from allocation control channel allocating section 101 by respective coding rates corresponding to the MCS levels, and modulate the encoded uplink allocation information by respective modulation schemes corresponding to the MCS's.

As in this example, if allocation control channels of a plurality of MCS's are used, a mobile station closer to the center of a cell is allocated an allocation control channel of a higher MCS level.

Also, uplink data from a mobile station close to the center of a cell can be received by a base station with sufficient transmission power, so that, uplink data from the mobile station close to the center of the cell shows good error rate performance and requires a smaller number of transmissions. On the other hand, uplink data from a mobile station close to a boundary of a cell cannot be received by a base station with sufficient transmission power, and, consequently, uplink data from a mobile station close to a boundary of cells shows good error rate performance and requires a larger number of transmissions.

Therefore, a mobile station that is close to the center of a cell and that is allocated an allocation control channel of a higher MCS level uses an ACK/NACK channel associated with a larger number of transmissions less frequently. By contrast, a mobile station that is close to a boundary of a cell and that is allocated an allocation control channel of a lower MCS level uses an ACK/NACK channel associated with a larger number of transmissions more frequently.

Therefore, a downlink resource is shared by an ACK/NACK channel associated with an allocation control channel of the higher MCS level and an ACK/NACK channel associated with an allocation control channel of the lower MCS level. By this means, the same downlink resource is not used by an ACK/NACK channel associated with an allocation control channel of a higher MCS level and a larger number of transmissions, but is likely to be used only by an ACK/NACK channel associated with an allocation control channel of a lower MCS level. By this means, ACK/NACK channels are less likely to collide with each other. Therefore, with this example, it is possible to use downlink resources efficiently and improve data transmission efficiency by sharing downlink resources.

To be more specific, as shown in FIG. 7, downlink resources 1 to 6 (downlink resources 7 to 12) are shared by ACK/NACK channels CH #1, 1 to CH #1, 6 (ACK/NACK channels CH #2, 1 to CH #2, 6), associated with allocation control channel CH #1 (CH #2) of the lower MCS level and the first to sixth transmissions, and ACK/NACK channels CH #3, 1 to CH #3, 6 (ACK/NACK channels CH #4, 1 to CH #4, 6), associated with allocation control channel CH #3 (CH #4) of the higher MCS level and the first to sixth transmissions.

Here, as in sharing example 1-1, downlink resources 1 to 6 (downlink resources 7 to 12) shown in FIG. 7 are each shared by an ACK/NACK channel associated with the larger number of transmissions and an ACK/NACK channel associated with the smaller number of transmissions.

Thus, with this example, when allocation control channels can use a plurality of MCS's, a downlink resource is shared by a mobile station that uses a downlink resource with the larger number of transmissions more frequently (i.e. lower MCS level), and a mobile station that uses a downlink resource with the lower number of transmissions less frequently (i.e. higher MCS level). By this means, it is possible to use downlink resources more efficiently than in sharing example 1-1.

Also, although a case has been described above with this example where there are a plurality of ACK/NACK channels associated with allocation control channels of the higher MCS level and allocation control channels of the lower MCS level and where a downlink resource is shared by an ACK/NACK channel associated with the larger number of transmissions and an ACK/NACK channel associated with the smaller number of transmissions as in sharing example 1-1, it is equally possible to share a downlink resource in the same way as in sharing example 1-3.

### Sharing Example 1-5

With this example, a downlink resource is shared by an ACK/ANCK channel associated with an allocation control channel used more frequently and an ACK/NACK channel associated with an allocation control channel used less frequently.

Allocation control channel allocating section 101 according to this example allocates allocation control channels CH #1 to CH #4 to uplink allocation information #1 to #4, in ascending order from allocation control channel CH #1. For example, when the number of mobile stations to which uplink allocation information is allocated is one, allocation control channel allocating section 101 allocates uplink allocation information to allocation control channel CH #1, and, when the number of mobile stations to which uplink allocation information is allocated is two, allocation control channel allocating section 101 allocates uplink allocation information to allocation control channels CH #1 and CH #2.

That is, among allocation control channels CH #1 to CH #4, allocation control channel CH #1 is already used when uplink allocation information is allocated, and therefore allocation control channel CH #1 is used the most frequently, and allocation control channel CH #4 is used only when uplink allocation information is allocated to four mobile stations, which is the maximum number of mobile stations for allocation, and therefore allocation control channel CH #4 is used the least frequently.

Therefore, a downlink resource is shared by an ACK/NACK channel associated with an allocation control channel used more frequently and an ACK/NACK channel associated with an allocation control channel used less frequently. By this means, there is a high possibility that one ACK/NACK channel is used while the other ACK/NACK channel is not used. Therefore, ACK/NACK channels sharing a downlink resource are less likely to collide with each other.

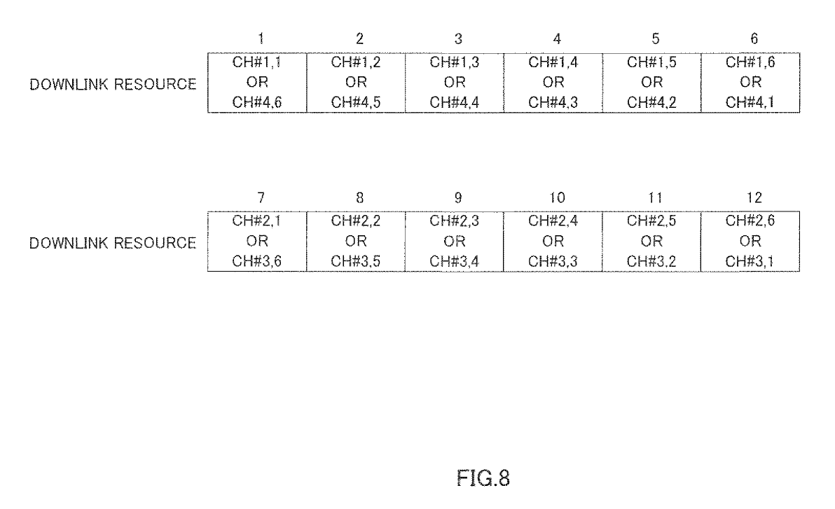

This will be described below in detail. As shown in FIG. 8, downlink resources 1 to 6 (downlink resources 7 to 12) are shared by ACK/NACK channels CH #1, 1 to CH #1, 6 (ACK/NACK channels CH #2, 1 to CH #2, 6), which are associated with allocation control channel CH #1 (CH #2) used more frequently and the first to sixth transmissions, and ACK/NACK channels CH #4, 1 to CH #4, 6 (ACK/NACK channels CH #3, 1 to CH #3, 6), which are associated with allocation control channel CH #4 (CH #3) used less frequently and the first to sixth transmissions.

Here, as in sharing example 1-1, downlink resources 1 to 6 (downlink resources 7 to 12) shown in FIG. 8 are each shared by an ACK/NACK channel associated with the larger number of transmissions and an ACK/NACK channel associated with the smaller number of transmissions.

For example, when the number of mobile stations for allocation is two, uplink allocation information are allocated to allocation control channels CH #1 and CH #2. Therefore, in downlink resources 1 to 6 (downlink resources 7 to 12) shown in FIG. 8, only ACK/NACK channels CH #1, 1 to CH #1, 6 (ACK/NACK channels CH #2, 1 to CH #2, 6) are used. Therefore, a collision with ACK/NACK channels CH #3, 1 to CH #3, 6 (ACK/NACK channels CH #4, 1 to CH #4, 6) does not occur at all.

Thus, with this example, ACK/NACK channels in downlink resources are less likely to collide with each other, so that it is possible to use downlink resources more efficiently than in sharing example 1-1.

Also, although a case has been described above with this example where there are a plurality of ACK/NACK channels associated with allocation control channels used more frequently and allocation control channels used less frequently and where a downlink resource is shared by an ACK/NACK channel associated with the larger number of transmissions and an ACK/NACK channel associated with the smaller number of transmissions as in sharing example 1-1, it is equally possible to share downlink resources in the same way as in sharing example 1-3.

### Sharing Example 1-6

With this example, a downlink resource is shared by more ACK/NACK channels when the number of transmissions increases.

First, sharing example 1-6-1 will be explained in detail.

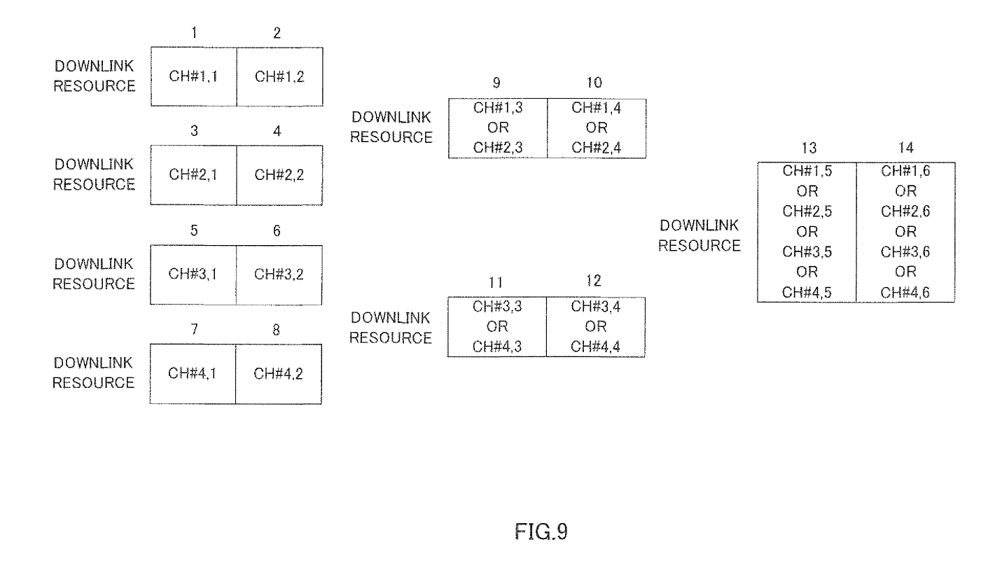

As shown in FIG. 9, ACK/NACK channels CH #1, 1, CH #1, 2, CH #2, 1, CH #2, 2, CH #3, 1, CH #3, 2, CH #4, 1 and CH #4, 2, each associated with the first transmission or the second transmission in allocation control channels CFI #1 to CH #4, are placed in downlink resources 1 to 8, respectively.

Also, as shown in FIG. 9, downlink resource 9 is shared by ACK/NACK channels CH #1, 3 and CH #2, 3, each associated with the third transmission, in allocation control channels CH #1 and CH #2. Also, downlink resource 10 is shared by ACK/NACK channels CH #1, 4 and CH #2, 4, each associated with the fourth transmission, in allocation control channels CH #1 and CH #2. Also, downlink resource 11 is shared by ACK/NACK channels CH #3, 3 and CH #4, 3, each associated with the third transmission, in allocation control channels CH #3 and CH #4. Also, downlink resource 12 is shared by ACK/NACK channels CH #3, 4 and CH #4, 4, each associated with the fourth transmission, in allocation control channels CH #3 and CH #4.

Also, as shown in FIG. 9, downlink resource 13 is shared by ACK/NACK channels CH #1, 5, CH #2, 5, CH #3, 5 and CH #4, 5, each associated with the fifth transmission, in allocation control channels CH #1 to CH #4. Also, downlink resource 14 is shared by ACK/NACK channels CH #1, 6, CH #2, 6, CH #3, 6 and CH #4, 6, each associated with the sixth transmission, in allocation control channels CH #1 to CH #4.

That is, in the case of the first to second transmission, only one ACK/NACK channel is placed in each downlink resource. Also, in the case of the third to fourth transmission, each downlink resource is shared by two ACK/NAKC channels. Also, in the case of the fifth to sixth transmission, each downlink resource is shared by four ACK/NAKC channels.

By this means, an ACK/NACK channel associated with a smaller number of transmissions is less likely to collide with another ACK/NACK channel. By contrast, while an ACL/NACK channel associated with a larger number of transmissions is likely to collide with another ACK/NACK channel, it is extremely rare that the number of uplink data transmissions increases in each mobile station, so that ACK/NACK channels are less likely to collide with each other.

Next, sharing example 1-6-2 will be explained in detail.

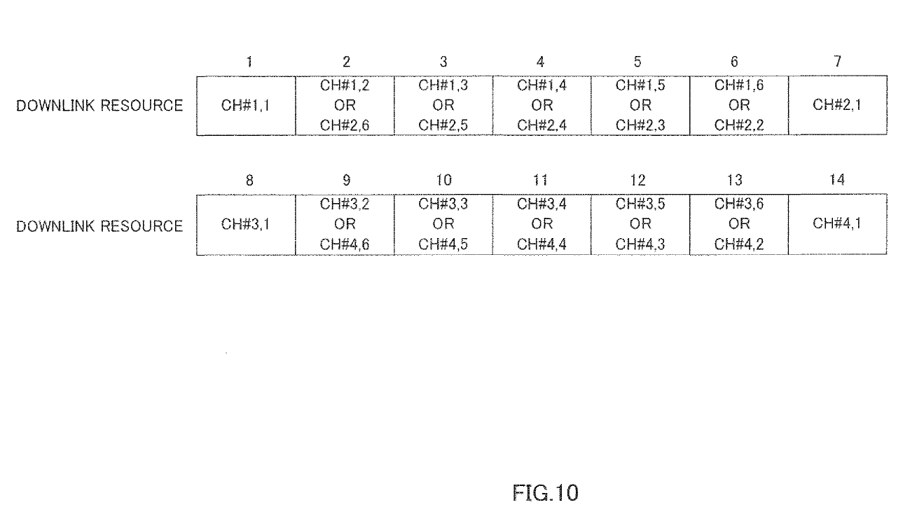

As shown in FIG. 10, ACK/NACK channels CH #1, 1 and CH #2, 1 (ACK/NACK channels CH #3, 1 and CH #4, 1), each associated with the first transmission in allocation control channels CH #1 and CH #2 (allocation control channels CH #3 and CH #4), are placed in downlink resources 1 and 7 (downlink resources 8 and 14), respectively.

Also, as shown in FIG. 10, downlink resources 2 to 6 (downlink resources 9 to 13) are shared by ACK/NACK channels CH #1, 2 to CH #1, 6 (ACK/NACK channels CH #3, 2 to CH #3, 6), associated with allocation control channel CH #1 (allocation control channel CH #3) and the second transmission to the sixth transmission, and ACK/NACK channels CH #2, 2 to CH #2, 6 (ACK/NACK channels CH #4, 2 to CH #4, 6), associated with allocation control channel CH #2 (allocation control channel CH #4) and the second transmission to the sixth transmission.

Here, as in sharing example downlink resources 2 to 6 are each shared by an ACK/NACK channel associated with the larger number of transmissions and an ACK/NACK channel associated with the smaller number of transmissions.

A base station always transmits an ACK signal or NACK signal to uplink data transmitted from a mobile station, and therefore ACK/NACK channels associated with the first transmission are always used amongst ACK/NACK channels associated with allocation control channels.

Therefore, as shown in FIG. 10, the downlink resources of ACK/NACK channels that are associated with the first transmission and always used, are not shared by other ACK/NACK channels, so that it is possible to avoid a collision of different ACK/NACK channels reliably. Also, by sharing ACK/NACK channels that are associated with the second and subsequent transmissions and that can be used when a retransmission occurs, by a plurality of ACK/NACK channels, it is possible to use downlink resources efficiently.

Thus, with this example, the number of different ACK/NACK channels sharing the same downlink resource with an ACK/NACK channel of a greater frequency of use decreases, so that it is possible to reduce a possibility that ACK/NACK channels collide with each other.

Sharing examples 1-1 to 1-6 have been described above.

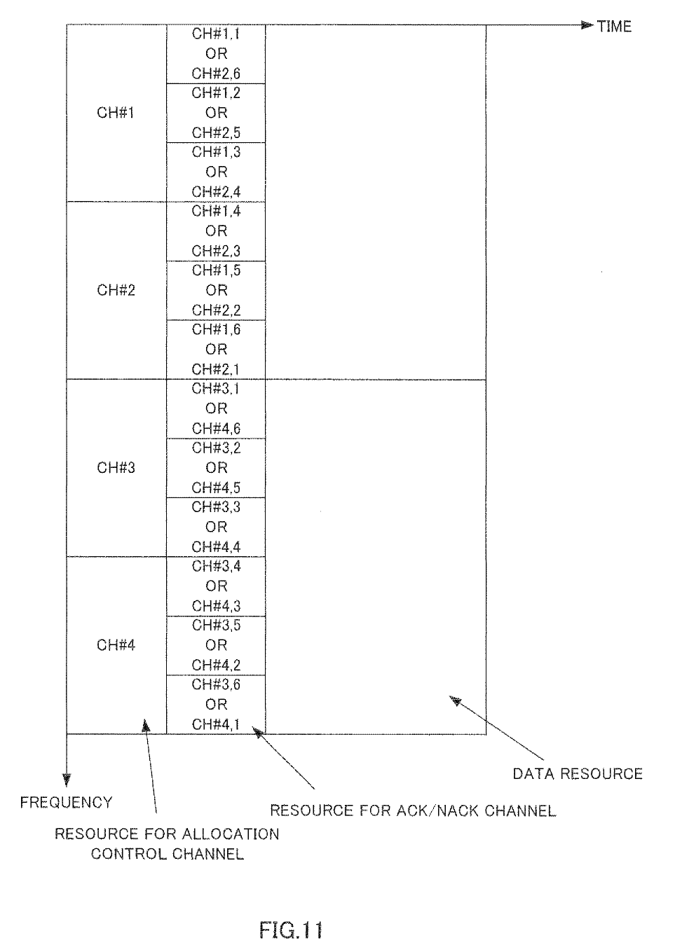

Also, the downlink resources shown in above FIGS. 3, 5, 7, 8, 9 and 10 represent downlink resources of a logical level, and, actually, ACK/NACK channels are placed in ACK/NACK channel resources of a physical level. For example, as shown in FIG. 11, the ACK/NACK channels shown in FIG. 3 are placed in ACK/NACK channel resources of a physical level defined in the frequency domain and time domain. Here, although frequencies and time are physical resources for ACK/NACK channels in FIG. 11, it is equally possible to use space and codes as physical resources for ACK/NACK channels. Also, unlike FIG. 11, physical resources for ACK/NACK channels may not be provided in a consecutive manner but may be provided in a distributed manner in the frequency domain and time domain.

Thus, according to the present embodiment, ACK/NACK channels associated with different allocation control channels and different numbers of transmissions share a downlink resource efficiently, so that it is possible to reduce downlink resources in which ACK/NACK channels are placed, and therefore improve data transmission efficiency.

### Embodiment 2

A case will be explained with the present embodiment where an allocation control channel is formed in resource units called “CCE's” (Control Channel Elements).

Sharing examples of downlink resources according to the present embodiment will be explained below in detail.

### Sharing Example 2-1

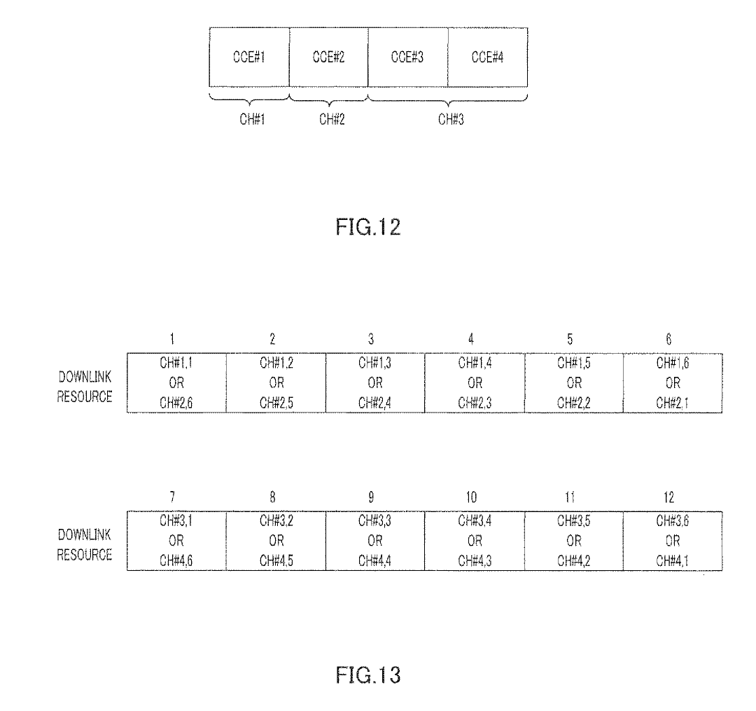

In the following explanation, as shown in FIG. 12, four CCE's #1 to #4 are used. Also, allocation control channels are formed with CCE's of continuous CCE numbers among four CCE's, where the number of CCE's varies every subframe. For example, as shown in FIG. 12, allocation control channel CH #1 is formed with one CCE of CCE #1, allocation control channel CH #2 is formed with one CCE of CCE #2, and allocation control channel CH #3 is formed with two CCE's of CCE #3 and CCE #4. Also, an allocation control channel corresponding to a lower MCS level is formed with more CCE's.

In this example, a downlink resource is shared by a plurality of ACK/NACK channels associated with a plurality of allocation control channels formed with a plurality of adjacent CCE's.

This will be explained below in detail. Here, as shown in FIG. 12, allocation control channels CH #1 to CH 43 are formed using CCE's #1 to #4. In this case, a base station reserves in advance maximum four allocation control channels CH #1 to CH #4 corresponding to four CCE's #1 to #4 respectively. Also, the maximum possible number of uplink data transmissions is six.

As shown in FIG. 13, downlink resources 1 to 6 (downlink resources 7 to 12) are shared by ACK/NACK channels CH #1, 1 to CH #1, 6 (ACK/NACK channels CH #3, 1 to CH #3, 6), associated with the first transmission to the sixth transmission of allocation control channel CH #1 (CH #3), and ACK/NACK channels CH #2, 1 to CH #2, 6 (ACK/NACK channels CH #4, 1 to CH #4, 6), associated with the first transmission to the sixth transmission of allocation control channel CH #2 (CH #4) adjacent to allocation control channel CH #1 (CH #3).

Here, as in sharing example 1-1 of Embodiment 1, downlink resources 1 to 6 (downlink resources 7 to 12) shown in FIG. 13 are each shared by an ACK/NACK channel associated with the larger number of transmissions and an ACK/NACK channel associated with the smaller number of transmissions.

Therefore, downlink resources 1 to 6 shown in FIG. 13 are shared by ACK/NACK channels CH #1, 1 to CH 41, 6, associated with allocation control channel CH #1 formed with CCE #1, and ACK/NACK channels CH #2, 1 to CH #2, 6, associated with allocation control channel CH #2 formed with CCE #2, so that it is possible to provide the same effect as in sharing example 1-1.

On the other hand, in downlink resources 7 to 12 shown in FIG. 13, allocation control channel CH #3 is formed with CCE #3 and CCE #4, and there is one response signal to uplink data of a mobile station to which allocation control channel CH #3 is allocated. Therefore, in this case, allocation control channel CH #4 is not used, and ACK/NACK channels CH #4, 1 to CH #4, 6, associated with allocation control channel CH #4, are not used. That is, in downlink resources 7 to 12, ACK/NACK channels do not collide with each other at all.

Thus, with this example, a downlink resource is shared by a plurality of ACK/NACK channels associated with allocation control channels formed with a plurality of adjacent CCE's. By this means, when one allocation control channel is formed by connecting a plurality of CCE's, ACK/NACK channels do not collide with each other, so that it is possible to use downlink resources efficiently.

Here, although a case has been described above with this example where a downlink resource is shared by an ACK/NACK channel associated with the larger number of transmissions and an ACK/NACK channel associated with the smaller number of transmissions as in sharing example 1-1 of Embodiment 1, it is equally possible to share a downlink resource in the same way as in sharing example 1-3 of Embodiment 1.

### Sharing Example 2-2

In this example, a case will be explained where a plurality of CCE's are shared and used between uplink allocation control channels and downlink allocation control channels.

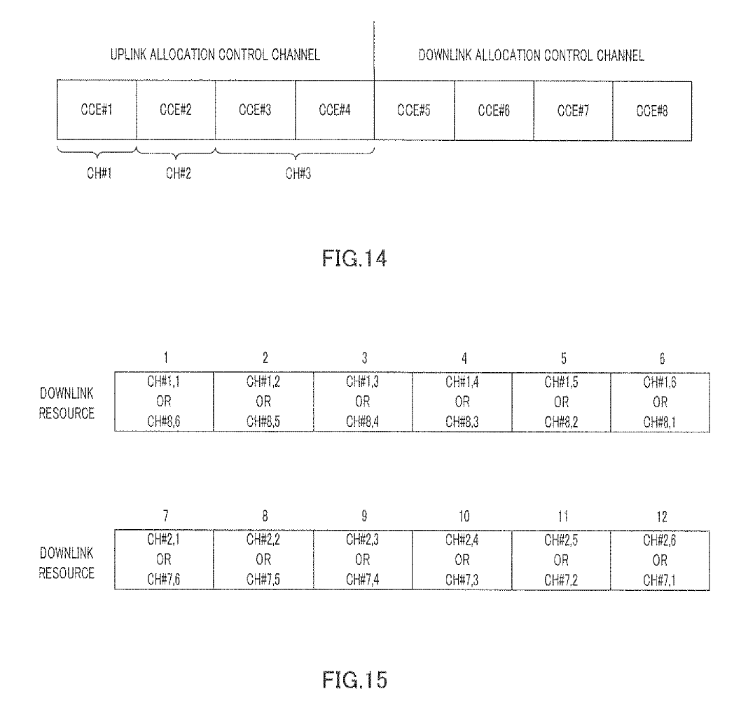

This will be explained below in detail. Here, as shown in FIG. 14, eight channels CCE's #1 to #8 are used. Also, uplink allocation control channels are used in ascending order from CCE #1 to CCE #8, while downlink allocation control channels are used in descending order from CCE #8 to CCE #1. Also, the number of CCE's used as uplink allocation control channels and the number of CCE's used as downlink allocation control channels vary every subframe. That is, the number of CCE's used as uplink allocation control channels increases when the amount of uplink communication is large, while the number of CCE's used as downlink allocation control channels increases when the amount of downlink communication is large.

That is, in CCE #1 to CCE #8 shown in FIG. 14, CCE #1 is used the most frequently as an uplink allocation control channel, while CCE #8 is used the most frequently as a downlink allocation control channel. In other words, CCE #8 is used the least frequently as an uplink allocation control channel.

Therefore, with this example, as in sharing examples 1 to 5 in Embodiment 1, a downlink resource is shared by an ACK/NACK channel, associated with an uplink allocation control channel formed with a CCE used more frequently, and an ACK/NACK channel, associated with an uplink allocation control channel formed with a CCE used less frequently.

This will be explained below in detail. Here, as shown in FIG. 14, CCE's #1 to #4 are used as uplink allocation control channels, and CCE's #5 to #8 are used as downlink allocation control channels. Also, CCE's #1 to #4 form allocation control channels CH #1 to CH #3 as shown in FIG. 14. Here, a base station reserves in advance downlink resources of maximum eight allocation control channels CH #1 to CH #8 corresponding to eight CCE's #1 to #8 respectively, as allocation control channels. Also, the maximum possible number of uplink data transmissions is six. Here, for ease of explanation, only uplink allocation control channel CH #1 formed with CCE #1 and uplink allocation control channel CH #2 formed with CCE #2, will be explained.

As shown in FIG. 15, downlink resources 1 to 6 (downlink resources 7 to 12) are shared by ACK/NACK channels CH #1, 1 to CH #1, 6 (ACK/NACK channels CH #2, 1 to CH #2, 6), associated with the first transmission to the sixth transmission of allocation control channel CH #1 (CH #2) and ACK/NACK channels CH #8, 1 to CH 48, 6 (ACK/NACK channels CH #7, 1 to CH #7, 6), associated with the first transmission to the sixth transmission of allocation control channel CH #8 (CH #7).

Here, as in sharing example 1-1 of Embodiment 1, downlink resources 1 to 6 (downlink resources 7 to 12) shown in FIG. 15 are each shared by an ACK/NACK channel associated with the larger number of transmissions and an ACK/NACK channel associated with the smaller number of transmissions.

As shown in FIG. 14, CCE's #1 to #4 are used as uplink allocation control channels and CCE's #5 to #8 are used as downlink allocation control channels, and therefore ACK/NACK channels CH #8, 1 to CH #8, 6 (ACK/NACK channels CH #7, 1 to CH #7, 6) are not used as ACK/NACK channels associated with uplink allocation control channels.

Therefore, in downlink resources 1 to 6 (downlink resources 7 to 12) shown in FIG. 15, only ACK/NACK channels CH #1, 1 to CH #1, 6 (ACK/NACK channels CH #2, 1 to CH #2, 6) are used, so that ACK/NACK channels CH #8, 1 to CH #8, 6 (ACK/NACK channels CH #7, 1 to CH #7, 6) do not collide with each other at all.

Thus, with this example, a downlink resource is shared by an ACK/NACK channel used more frequently and an ACK/NACK channel used less frequently, so that it is possible to reduce a possibility that ACK/NACK channels collide with each other. Therefore, even when a plurality of CCE's are shared and used between uplink data allocation control channels and downlink data allocation control channels, it is possible to improve data transmission efficiency.

Also, although a case has been described above with this example where a downlink resource is shared by an ACK/NACK channel associated with the larger number of transmissions and an ACK/NACK channel associated with the smaller number of transmissions as in sharing example 1-1 of Embodiment 1, it is equally possible to share a downlink resource in the same way as in sharing example 1-3 of Embodiment 1.

Sharing examples 2-1 to 2-2 have been described above.

Thus, according to the present embodiment, even when allocation control channels are formed with a plurality of CCE's, it is possible to improve data transmission efficiency.

Embodiments of the present invention have been described above.

Also, although cases have been described above with embodiments where an uplink response signal is transmitted, it is equally possible to apply the present invention to a downlink response signal. For example, it is possible to apply the present invention to a downlink response signal by performing the same processing in a mobile station as in above base station 100. Here, downlink resources are allocated by the base station. That is, the mobile station does not perform the same processing as in allocation control channel allocating section 101 in above base station 100. Therefore, the mobile station transmits a response signal using an ACK/NACK channel associated with an uplink control channel for requesting an allocation of downlink data. Alternatively, the mobile station transmits a response signal using an ACK/NACK channel associated with a downlink control channel for notifying the allocation of downlink data.

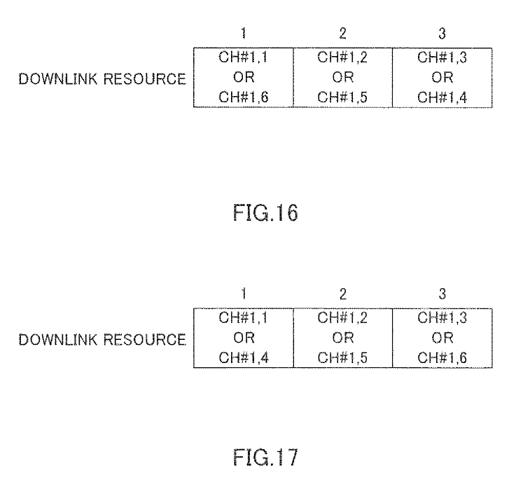

Also, although cases have been described above with embodiments where a downlink resource is shared by a plurality of ACK/NACK channels associated with different allocation control channels, it is equally possible to share a downlink resource by a plurality of ACK/NACK channels associated with different numbers of transmissions in the same allocation control channel. For example, in downlink resources 1 to 3 as shown in FIG. 16, as in sharing example 1-1 of Embodiment 1, downlink resource 1 may be shared by ACK/NACK channel CH #1, 1, associated with allocation control channel CH #1 and the first transmission, and ACK/NACK channel CH #1, 6, associated with allocation control channel CH #1 and the sixth transmission; downlink resource 2 may be shared by ACK/NACK channel CH #1, 2, associated with allocation control channel CH #1 and the second transmission, and ACK/NACK channel CH #1, 5, associated with allocation control channel CH #1 and the fifth transmission; and downlink resource 3 may be shared by ACK/NACK channel CH #1, 3, associated with allocation control channel CH #1 and the third transmission, and ACK/NACK channel CH #1, 4, associated with allocation control channel CH #1 and the fourth transmission.

Also, in downlink resources 1 to 3 as shown in FIG. 17, as in sharing example 1-3 of Embodiment 1, downlink resource 1 may be shared by ACK/NACK channel CH #1, 1, associated with allocation control channel CH #1 and the first transmission, and ACK/NACK channel CH #1, 4, associated with allocation control channel CH #1 and the fourth transmission; downlink resource 2 may be shared by ACK/NACK channel CH #1, 2, associated with allocation control channel CH #1 and the second transmission, and ACK/NACK channel CH #1, 5, associated with allocation control channel CH #1 and the fifth transmission; and downlink resource 3 may be shared by ACK/NACK channel CH #1, 3, associated with allocation control channel CH #1 and the third transmission, and ACK/NACK channel CH #1, 6, associated with allocation control channel CH #1 and the sixth transmission.

Also, an allocation control channel used for explanation in the above embodiments may be referred to as a “PDCCH (Physical Downlink Control CHannel),” “SCCH (Shared Control CHannel),” “L1/L2 control channel,” “UL grant channel,” or “CCCH (Common Control CHannel)”. Also, an ACK/NACK channel may be referred to as a “HICH (Hybrid ARQ Indicator CHannel).”

Also, although cases have been described above with embodiments where all downlink resources are shared by a plurality of ACK/NACK channels, it is equally possible to apply the present invention to part of downlink resources.

Also, with the present invention, it is possible to share downlink resources by combining the examples of downlink resource sharing explained with the above embodiments.

Also, although cases have been described above with embodiments where two ACK/NACK channels share one downlink resource, the number of ACK/NACK channels is not limited to two, and three or more ACK/NACK channels may share one downlink resource.

Also, a mobile station may be referred to as “UE,” and a base station may be referred to as “Node B.”

Also, the method of error detection is not limited to CRC.

Although a case has been described above with embodiment as an example where the present invention is implemented with hardware, the present invention can be implemented with software.

Furthermore, each function block employed in the description of each of the aforementioned embodiments may typically be implemented as an LSI constituted by an integrated circuit. These may be individual chips or partially or totally contained on a single chip. “LSI” is adopted here but this may also he referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-120848, filed on May 1, 2007, including the specification, drawings and abstract, is incorporated herein by reference in its entirety.

### INDUSTRIAL APPLICABILITY

The present invention is applicable to, for example, a mobile communication system.

1. A radio communication base station apparatus comprising:
a first allocating section that allocates resource allocation information of uplink data to a first control channel;
a second allocating section that allocates a response signal to the uplink data, to a second control channel associated with the first control channel and a number of uplink data transmissions; and
a placing section that places the second control channel in a downlink resource shared by a plurality of second control channels including the second control channel.

2. The radio communication base station apparatus according to claim 1, wherein the downlink resource is shared by the plurality of second control channels, associated with a plurality of first control channels respectively.

3. The radio communication base station apparatus according to claim 1, wherein the downlink resource is shared by a second control channel associated with a larger number of transmissions and a second control channel associated with a smaller number of transmissions.

4. The radio communication base station apparatus according to claim 3, wherein a sum of the larger number of transmissions and the smaller number of transmissions is the same between a plurality of downlink resources.

5. The radio communication base station apparatus according to claim 3, wherein a plurality of downlink resources are shared by the plurality of second control channels arranged in ascending order of the number of uplink data transmissions.

6. The radio communication base station apparatus according to claim 1, wherein the second allocating section allocates the response signal to the second control channel associated with the number of transmissions after the first control channel is notified.

7. The radio communication base station apparatus according to claim 1, wherein the downlink resource is shared by a second control channel, associated with a first control channel of a higher modulation and coding scheme level, and a second control channel, associated with a first control channel of a lower modulation and coding scheme level.

8. The radio communication base station apparatus according to claim 1, wherein the downlink resource is shared by a second control channel, associated with a first control channel used more frequently, and a second control channel, associated with a first control channel used less frequently.

9. The radio communication base station apparatus according to claim 1, wherein, when the number of transmissions increases, the downlink resource is shared by a larger number of second control channels.

10. The radio communication base station apparatus according to claim 1, wherein the first allocating section allocates the resource allocation information to the first control channel formed with a plurality of control channel elements.

11. The radio communication base station apparatus according to claim 1, wherein the downlink resource is shared by the plurality of second control channels associated with a plurality of first control channels formed with a plurality of adjacent control channel elements.

12. The radio communication base station apparatus according to claim 1, wherein the downlink resource is shared by a second control channel, associated with a first control channel formed with a control channel element used more frequently, and a second control channel, associated with a first control channel formed with a lower control channel element used less frequently.

13. A radio communication mobile station apparatus comprising:
an allocating section that allocates a response signal to downlink data that is allocated using a first control channel, to a second control channel associated with the first control channel and a number of downlink data transmissions; and
a placing section that places the second control channel in an uplink resource shared by a plurality of second control channels including the second control channel.

14. A resource sharing method comprising sharing a single downlink resource with a plurality of second control channels associated with different numbers of uplink data transmissions.
